(19) United States
(12) Patent Application Publication
(10) Pub. No.: US 2025/0301410 A1
(43) Pub. Date: Sep. 25, 2025

(54) TECHNOLOGIES FOR DOWNLINK CELL-SPECIFIC TRANSMIT POWER ADJUSTMENT

(71) Applicant: Apple Inc., Cupertino, CA (US)

(72) Inventors: Fangli Xu, Beijing (CN); Alexander Sirotkin, Tel Aviv (IL); Anjaneyulu Maganti, Cupertino, CA (US); Chunxuan Ye, San Diego, CA (US); Dhruv Khati, San Jose, CA (US); Haijing Hu, Los Gatos, CA (US); Jie Cui, San Jose, CA (US); Krishna Myneni, San Jose, CA (US); Naveen Kumar R. Palle Venkata, San Diego, CA (US); Peng Cheng, Beijing (CN); Ping-Heng Kuo, London (GB); Ralf Rossbach, Munich (DE); Sanjeevi Balasubramanian, San Jose, CA (US); Yuexia Song, Beijing (CN); Yuqin Chen, Beijing (CN)

(73) Assignee: Apple Inc., Cupertino, CA (US)

(21) Appl. No.: 19/057,897

(22) Filed: Feb. 19, 2025

Related U.S. Application Data
(60) Provisional application No. 63/567,361, filed on Mar. 19, 2024.

(51) Int. Cl. H04W 52/14; H04W 76/28

(52) U.S. Cl. CPC H04W 52/143; H04W 76/28

(57) ABSTRACT

The present application relates to devices and components including apparatus, systems, and methods for downlink cell-specific transmit power adjustment.

### CROSS-REFERENCE TO RELATED APPLICATION

This application claims the benefit of U.S. Provisional Patent Application No. 63/567,361, filed on Mar. 19, 2024, which is herein incorporated by reference in its entirety for all purposes.

### FIELD

This application relates to the field of wireless networks and, in particular, to technologies for downlink cell-specific transmit power adjustment.

### BACKGROUND

As wireless networks have developed, the networks have grown to service more areas and more remote areas. An approach that has been proposed for the wireless networks to service more areas and more remote areas is the utilization of non-terrestrial networks (NTNs). In particular, satellites may be utilized within the NTNs to provide radio access network (RAN) service. This may address mobile broadband needs and public safety needs in unserved or underserved areas. NTNs may improve connectivity in a variety of scenarios including, for example, maritime, airplane, and railway scenarios. The use of the satellites within the NTNs presents many challenges.

### BRIEF DESCRIPTION OF THE DRAWINGS

FIG. 1 illustrates a network arrangement in accordance with some embodiments.

FIG. 2 illustrates an adjustment operation in accordance with some embodiments.

FIG. 3 illustrates another adjustment operation in accordance with some embodiments.

FIG. 4 illustrates another adjustment operation in accordance with some embodiments.

FIG. 5 illustrates another adjustment operation in accordance with some embodiments.

FIG. 6 illustrates another adjustment operation in accordance with some embodiments.

FIG. 7 illustrates an operational flow/algorithmic structure in accordance with some embodiments.

FIG. 8 illustrates another operational flow/algorithmic structure in accordance with some embodiments.

FIG. 9 illustrates another operational flow/algorithmic structure in accordance with some embodiments.

FIG. 10 illustrates a user equipment in accordance with some embodiments.

FIG. 11 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); the phrase “(A)B” means (B) or (A and B), that is, A is optional; and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

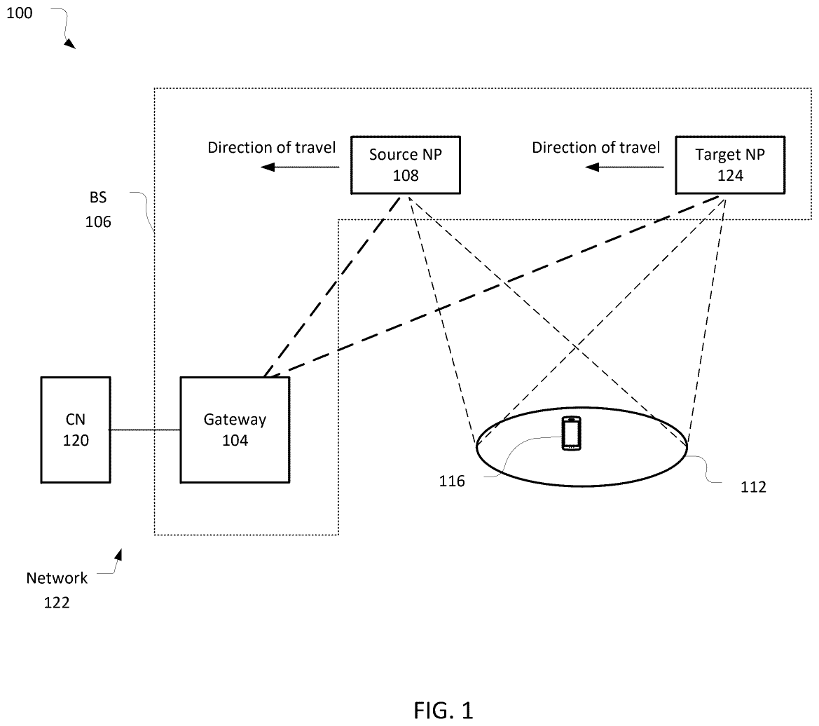

FIG. 1 illustrates an example network arrangement 100 in accordance with some embodiments. The network arrangement 100 may employ one or more non-terrestrial components and may, therefore, be referred to as a non-terrestrial network (NTN).

The network arrangement 100 may include a gateway 104 coupled with a source NTN payload (NP) 108 to provide a serving cell 112 for a user equipment (UE) 116. The gateway 104 and the source NP 108 may collectively be referred to as a base station 106. The base station 106 may be part of a radio access network (RAN) that provides services to UEs such as the UE 116. The gateway 104, which may be a terrestrial component of the base station 106, may be coupled with the source NP 108 by a feeder link. The source NP 108, which may be a non-terrestrial component of the base station 106, may be coupled with the UE 116 by a service link that supports a Uu interface (e.g., a New Radio (NR) Uu interface). The serving cell 112 may be associated with a larger geographic area than a serving cell provided by a terrestrial network.

In some embodiments, the source NP 108 may transparently forward communications between the gateway 104 and the UE 116. In other embodiments, the source NP 108 may include additional base station functionality. The gateway 104 may serve one or more NPs and the source NP 108 may be served by one or more gateways.

The network arrangement 100 may also include a core network (CN) 120 coupled with the gateway 104 via a fiber optic or wireless backhaul. The CN 120 may provide functions for the UEs that form a connection with the base station, such as subscriber profile information, subscriber location, authentication of services, or switching functions for voice and data sessions.

As used herein, operations described with respect to network 122 may be performed by one or more components of a RAN (for example, base station 106) or the CN 120.

In some embodiments, the source NP 108 may provide a quasi-earth-fixed service link by using beam(s) to provide the serving cell 112 for a geographic area for limited time. As the source NP 108 moves away from the geographic area associated with the serving cell 112, provision of the serving cell 112 may be switched to a target NP 124. The target NP 124 may establish a feeder link with the gateway 104 (and become part of the base station 106) and may take over the quasi-earth-fixed service link that provides the serving cell 112. In some embodiments, the physical cell identity (PCI) associated with the serving cell 112 may be the same before and after the switch. NP switching without PCI change may not require layer 3 (L3) mobility.

The NPs 108/124 may be spaceborne vehicles such as, for example, low-Earth orbit (LEO) satellites, medium-Earth orbit (MEO) satellites, geosynchronous Earth orbit (GEO) satellites, or high-Earth orbit (HEO) satellites. The NPs 108/124 may additionally/alternatively be airborne vehicles such as, for example, high-altitude platform stations (HAPS) or other atmospheric satellites.

For purposes of description of embodiments of the present disclosure, the network arrangement 100 may be associated with various assumptions. For example, the network arrangement 100 may employ frequency division duplexing (FDD) or time-division duplexing (for example, for HAPS or air-to-ground scenarios). The network arrangement 100 may have an earth-fixed tracking area. The UE 116 may be enabled with satellite capabilities including, for example, global navigation satellite system (GNSS) capabilities. In some embodiments, the UE 116 may be a handheld device that operates in frequency range 1 (FR1) and have for example, a power class 3; a very-small-aperture terminal (VSAT) device with an external antenna that operates in frequency range 2 (FR2); etc. The network arrangement 100 may provide a transparent payload. While these assumptions may be relevant to some embodiments, they are not requirements.

The network 122 may configure a cell-specific transmit power in radio resource control (RRC) configurations of, for example, a system information block 1 (SIB1). The cell-specific transmit power may be a value that is to be used as a constant transmission power for transmission of reference signals such as synchronization signal and physical broadcast channel blocks (SSBs).

The cell-specific transmit power may be provided to an idle/inactive UE by a parameter in a SIB1 configuration. For example, the cell-specific transmit power may be provided by an ss-PBCH-BlockPower parameter in a serving cell configuration common SIB (ServingCellConfigCommonSIB) information element (IE). The ss-PBCH-BlockPower parameter may be an average EPRE of resource elements that carry secondary synchronization signals in dBm that the network may use for SSB transmission. In other embodiments, the cell-specific transmit power may be provided to a connected UE by a parameter of an RRC signal. For example, the cell-specific transmit power may be provided as an ss-PBCH-BlockPower parameter of an SSB configuration or a downlink positioning reference signal resource power (dl-PRS-ResourcePower) configuration.

The UE 116 may use the cell-specific transmit power to estimate a downlink (DL) pathloss. The DL pathloss may be used for determining an uplink transmit power for random access channel (RACH) transmissions, uplink small-data transmissions, or other transmissions. In some embodiments, the UE 116 may use an estimate of the DL pathloss to determine an uplink transmit power in a manner similar to that described in, for example, section 7.1.1 of Third Generation Partnership Project (3GPP) Technical Specification (TS) 38.213 v18.1.0 (2024 Jan. 18).

Providing a constant transmit power for downlink reference signals (for example, SSBs) may be relatively straightforward for terrestrial networks. However, NTNs may be more challenged in this regard. A satellite transmit power may vary for a number of reasons. For example, the satellite may provide a different power based on a solar battery level. Thus, the satellite may have a higher transmit power in direct sunlight and a lower transmit power when the satellite is not in direct sunlight (e.g., in the Earth's shadow). This may apply to both GEO and LEO satellites. A satellite's transmit power may also vary due to power ramping when a satellite starts or stops providing an NTN cell in a fixed area. This may be applicable to LEO satellites. In some instances, a satellite within a particular elevation range may need to limit power for a particular antenna based on an elevation angle from the antenna. For example, a satellite may need to ramp power up/down for certain antennas based on when it is coming up/leaving view. This may be applicable to LEO satellites.

In some embodiments, it may be desirable for the network 122 to vary downlink (DL) transmit (Tx) power for other reasons. For example, the network 122 may wish to reduce the DL Tx power for a network saving purpose, which may be applicable to both terrestrial networks and NTNs. For example, the network 122 may reduce DL cell-specific Tx power during a time in which there are no or very few UEs in a cell.

As mentioned above, typically a network will use a constant cell-specific Tx power for SSB transmissions in a serving cell. The configuration of the cell-specific Tx power may be provided in SIB1. If the configuration changes, the network may employ a system information modification procedure. This procedure may include the network transmitting a modified SIB1 with the updated cell-specific transmit power. The modified SIB1 may also include a changed system information value tag (systemInfoValueTag) value. The network may also transmit a paging message with a system information modification parameter (systemInfoModification) set to true. The change of the transmit power configuration cannot be done quickly and the re-acquisition of the updated configuration in the SIB1 will lead to additional IDLE/INACTIVE UE power consumption.

Various embodiments may facilitate dynamic provision of cell-specific transmit power for downlink reference signal transmission. This may be used to accommodate NTN cell-specific characteristics (for example, when transmit power provided by a satellite is varying due to the battery issue, power ramping, and elevation angle adjustment) or network power-saving purposes (for example, to allow for transmit power for all downlink reference signals to be appropriately reduced when the cell load is light).

As discussed above, existing methods of changing the cell-specific transmit power value through SIB1 modification are relatively slow and can lead to additional signaling overhead. These methods may not be suitable for instances in which the cell-specific transmit power is varying or dynamically changed. Thus, embodiments describe enhancements that support changing the cell specific transmit power in downlink without the need for a SIB modification procedure. With these enhancements, cell specific transmit power for downlink reference signal transmission in be dynamically changed without SIB modification procedure and RRC reconfiguration procedure.

In a first aspect, the network 122 may provide a plurality of candidate DL Tx power configurations to the UE 116. These configurations may be provided by RRC signaling. The UE 116 may then select one of candidate downlink transmit power configurations to apply. The configurations can provide the DL Tx power value as an absolute value, a delta value (based on reference value that may be a previous value indicated, a default value, etc.), or a value determined from a formula based on a reference value (for example, a previous value, a default value, etc.).

Signaling, selection, content, and use of the DL Tx power configurations may be as follows.

In some embodiments, the UE 116 may detect one or more conditions and select a DL Tx power configuration for application based on the detected one or more conditions. The one or more conditions may include a time, location, or network indication. The conditions may include a plurality of these conditions that are to be detected by the UE 116 for selection of the DL Tx power configuration.

The network indication may be provided by layer 1 (L1) or layer 2 (L2) signaling. In some embodiments, the network indication may identify DL Tx power configuration to be applied using, for example, a configuration identifier (ID)/index. In some embodiments, the network indication may additionally/alternatively include a valid time duration in which the indicated DL Tx power configuration is to be applied.

In some embodiments, the UE 116 may determine a timing in which the UE 116 is to apply the newly selected DL Tx power configuration in accordance with one or more of the following options.

In a first option, the UE 116 may apply the newly selected DL Tx power configuration at a special time point. In some embodiments, the time point may be a starting point of a corresponding time duration. The time duration may be provided in coordinated universal time (UTC) or in global positioning system (GPS) time. In some embodiments, the time point may be at a start of a next system information (SI) modification period.

In a second option, the UE 116 may apply the newly selected DL Tx power configuration relative to a timepoint in which the UE 116 receives the indication of the configuration. In some embodiments, the UE 116 may apply the new value upon receiving the indication without delay (other than the time necessary for processing the new configuration and updating the values). In some embodiments, the UE 116 may apply the new value at a timing offset from the time point of receiving the indication. The offset may be predefined by, for example, a Technical Specification, or statically/dynamically configured.

In some embodiments, the UE 116 may determine a time duration in which the UE 116 is to apply the newly selected DL Tx power configuration in accordance with one or more of the following options.

In a first option, the time duration may be configured together with each candidate DL Tx power configuration. For example, the network 122 may provide both the configurations and associated time durations in downlink signaling (such as, for example, RRC signaling).

In a second option, the time duration may be explicitly indicated by the network 122 along with the indication of the selected candidate DL Tx power configuration. For example, the network 122 may provide L1/L2 signaling with both an indication of a selected candidate DL Tx power configuration and an associated time duration in which that configuration is to be used.

In a third option, the UE 116 may apply a value from a DL Tx power configuration until the UE 116 receives a network indication (in L1/L2 signaling, for example) of a new value for the UE 116 to apply.

In some embodiments, the network 122 may configure a default value. The default value may be applied at a beginning of receipt of the RRC configuration, or when a condition for use of a different value is not met.

In some embodiments, the network 122 may provide a DL Tx power configuration per SSB. For example, a DL Tx power configuration may include a parameter that associates the configuration with a particular SSB configuration. For another example, the DL Tx power configuration may be added to the SSB configuration.

In some embodiments, the network 122 may associate a DL Tx power configuration with some other configuration/indication. Thus, the UE 116 may interpret receipt of the other configuration/indication as a command to utilize the associated DL Tx power configuration. The other configuration/indication may be associated with, for example, a network-energy-saving (NES) state, a cell discontinuous reception (DRX)/discontinuous transmission (DTX) state, or a number of SSB, or an SSB periodicity. For example, if Configuration #1 is associated with a NES state or a specific SSB periodicity, the UE 116 will adjust the Tx power according to Configuration #1 when the NES state or specific SSB periodicity is activated.

The signaling, selection, content, and use of the DL Tx power configurations described with respect to the first aspect may be applicable whether the UE 116 is in a connected, idle, or inactive state.

In a second aspect, the network 122 may be allowed to change the Tx power dynamically without performing a SIB modification procedure. With this aspect, in order to ensure that the UE 116 has the current Tx power, the UE 116 may be required to reacquire the SIB1 before performing an initial access. In some embodiments, the network 122 may provide an indication of whether the UE 116 is required to reacquire the SIB1 before performing an initial access. This indication may be provided as a one-bit indication in a SIB1 message or another message from the network. The second aspect may be applicable to the UE 116 while it is in an idle or inactive state.

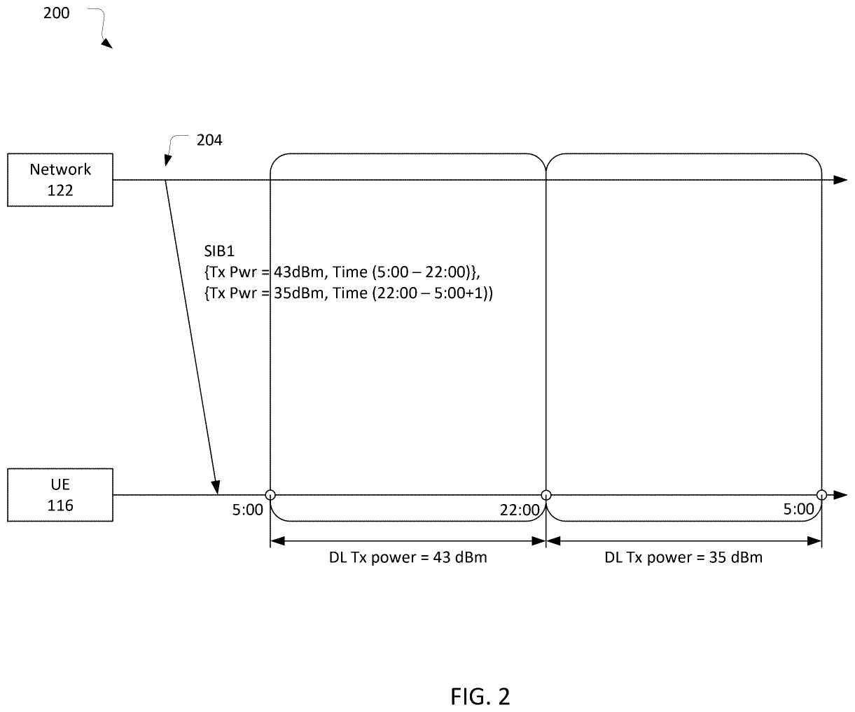

FIG. 2 illustrates an adjustment operation 200 in accordance with some embodiments. The adjustment operation 200 may provide different DL Tx power configurations for different time periods using RRC signaling.

The adjustment operation 200 may include a network configuration phase in which the network 122 transmits a SIB1 at 204. The SIB1 may be an RRC message that is transmitted by a physical downlink shared channel (PDSCH). The SIB1 may include a plurality of DL Tx power configurations and associated time periods. The time periods in this case may be considered conditions associated with the corresponding configurations. When the conditions are met, the configuration may be applied.

The number of configurations/time periods may be provided according to network deployment/policy. As shown, the SIB includes two DL Tx power configurations. A first DL Tx power configuration may include a transmit power of 43 dBm and a time period of 5:00-22:00. The time duration/period may be provided by UTC time or GPS time as described above. A second DL Tx power configuration may include a transmit power of 35 DBM and a time period of 22:00-5:00+1. The specific configuration parameters (e.g., transmit powers and time duration/periods) used here and elsewhere are merely examples and not intended to be restrictive.

The adjustment operation 200 may further include a UE operation phase in which the UE 116 selects an applicable DL Tx power configuration based on a current time. For example, upon receiving the configurations in the SIB1, the UE 116 will thereafter determine which DL Tx power configuration based on the current time and time period provided by the SIB1. If the time period is provided by UTC time, the UE 116 can acquire the UTC time via a SIB.

In particular, at 5:00, the condition associated with the first DL Tx power configuration may be met and the UE 116 may apply a DL Tx power of 43 dBM. As discussed above, the DL Tx power may be applied by using the value to estimate a pathloss, which in turn, may be used to determine an uplink transmit power. The UE 116 may continue to use 43 dBm as the DL Tx power until, at 22:00 the condition associated with the first configuration is no longer met and the condition associated with the second configuration is met. At that point, the UE 116 may update the DL Tx power to 35 dBm based on the second configuration. This update may be done without additional signaling from the network 122

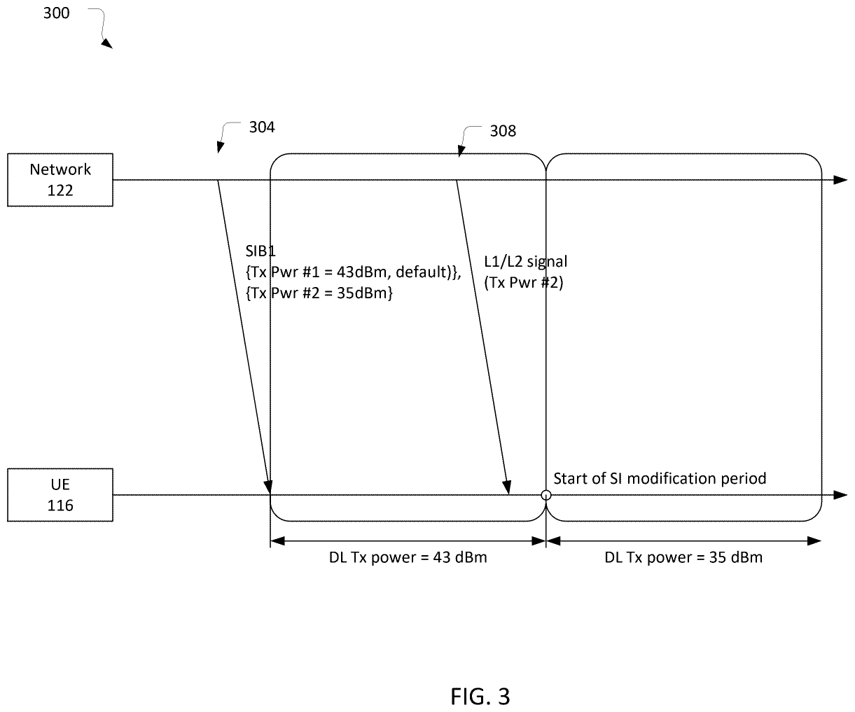

FIG. 3 illustrates an adjustment operation 300 in accordance with some embodiments. The adjustment operation 200 may provide different DL Tx power configurations and duration information using a combination of RRC signaling and L1/L2 signaling.

At 304, the network 122 may configure a plurality of DL Tx power configurations using RRC signaling. For example, the network 122 may transmit SIB1 at 304 with a first DL Tx power configuration and a second DL Tx power configuration. The first configuration may provide a transmit power of 43 dBm. The network 122 may also provide an indication that the first configuration is the default or initial configuration to be applied. This indication may be explicit or implied by, for example, order of presentation. In some embodiments, the power level of the configuration with the lowest/highest index (among all the candidate configurations) can be deemed as the default value or the highest/lowest power value can be regarded as the default value.

Upon receiving the SIB1, the UE 116 may apply the first configuration without delay.

At 308, the network 122 may send an L1/L2 signal that includes an indication that the second configuration is to be applied. The L1/L2 signal may be designed according to one or more of the following options. In a first option, the L1/L2 signaling may be downlink control information (DCI) with cyclic-redundancy check (CRC) bits scrambled with a common radio network temporary identifier (RNTI) for SIB change. In a second option, the L1/L2 signaling may be a media access control (MAC) control element (CE). The MAC CE may be scheduled by a DCI with CRC scrambled with a common RNTI or system information (SI)-RNTI. In a third option, the L1/L2 signaling may be DCI with CRC scrambled with a paging (P)-RNTI. In this case, the indication may be in the paging short message carried by the DCI with P-RNTI.

Upon receiving the indication in the L1/L2 signaling, the UE 116 may thereafter apply the indicated second configuration. In some embodiments, the UE 116 may apply the second configuration, and start using 35 dBm for the DL Tx power, at the beginning at the start of the next SI modification period as shown.

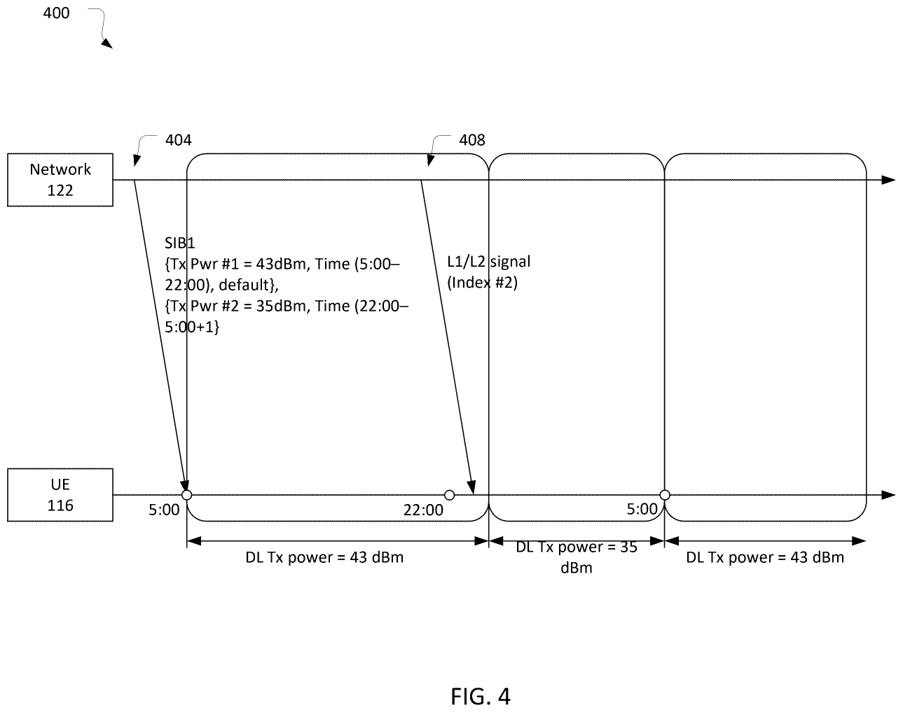

FIG. 4 illustrates an adjustment operation 400 in accordance with some embodiments. The adjustment operation 400 may provide different DL Tx power configurations and an applied value indication using a combination of RRC signaling and L1/L2 signaling.

At 404, the network 122 may configure a plurality of DL Tx power configurations using RRC signaling. For example, the network 122 may transmit SIB1 at 404 with a first DL Tx power configuration and a second DL Tx power configuration. The first configuration may provide a transmit power of 43 dBm and have an associated time period 5:00-22:00. The network 122 may also provide an indication that the first configuration is the default or initial configuration to be applied. This indication may be explicit or implied by, for example, order of presentation, index, or value. The second configuration may provide a transmit power of 35 dBm and have an associated time period 22:00-5:00+1. The time periods may be provided as UTC or GPS time.

In this example, the time periods may be conditions that are initially inactive. Thus, the UE 116, upon receiving the SIB1, may apply the first configuration without delay as it is the designated default configuration. The UE 116 may even apply the first configuration past the 22:00 time as the conditions are inactive and do not control the switching of the configurations. However, the network 122 may activate the conditions by sending an L1/L2 signal at 408. Thereafter, the UE 116 may check the conditions provided by the time periods and activate the second configuration as its condition is met, while the conditions of the first configuration are no longer met. At 5:00 the next day, the UE 116 may revert to the first configuration based on the activated conditions. While not shown, in some embodiments, the network 122 may send another L1/L2 signal to deactivate the conditions. In other embodiments, the conditions may be activated for a predetermined or preconfigured period of time. After which, they become deactivated and the UE 116 reverts to the default configuration.

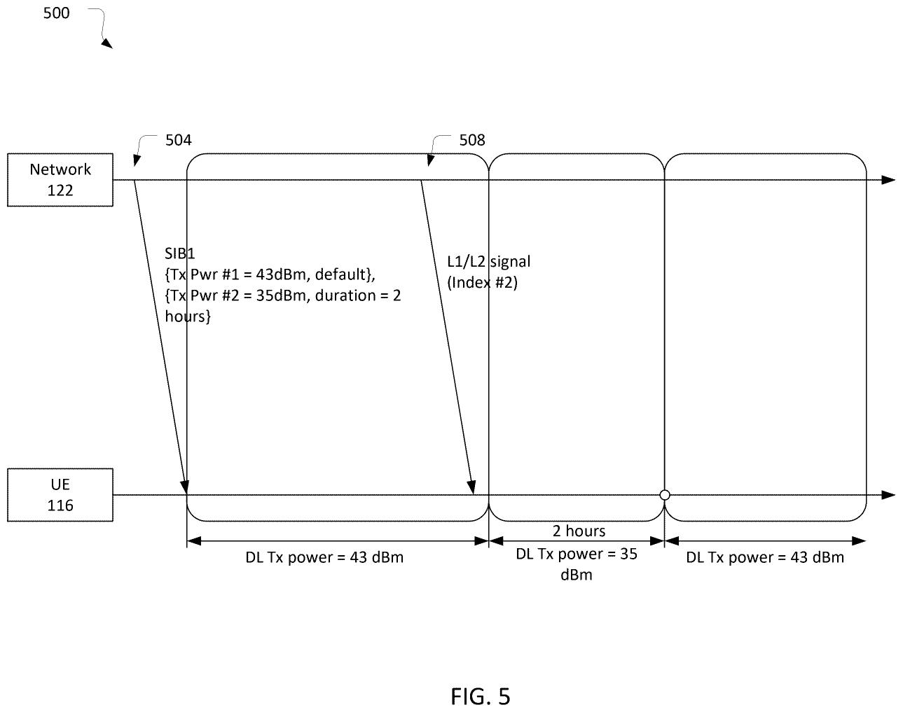

FIG. 5 illustrates an adjustment operation 500 in accordance with some embodiments. The adjustment operation 500 may provide different DL Tx power configurations and an applied value indication using a combination of RRC signaling and L1/L2 signaling.

At 504, the network 122 may configure a plurality of DL Tx power configurations using RRC signaling. For example, the network 122 may transmit SIB1 at 504 with a first DL Tx power configuration and a second DL Tx power configuration. The first configuration may provide a transmit power of 43 dBm. The network 122 may also provide an indication that the first configuration is the default or initial configuration to be applied. This indication may be explicit or implied by, for example, order of presentation, index, or value. The second configuration may provide a transmit power of 35 dBm and have an associated duration (or time length) of two hours.

The UE 116 may, upon receiving the SIB1, apply the first configuration without delay as it is the designated default configuration. At 508, the network 122 may send an L1/L2 signal with an indication that the second configuration is to be used. The UE 116 may then apply the second configuration, and use a DL Tx power of 35 dBm, for the indicated duration (e.g., two hours). After the duration expires, and assuming the UE 116 has not received any additional L1/L2 signaling indicated a new applied value, the UE 116 may revert to applying the first configuration as the default configuration.

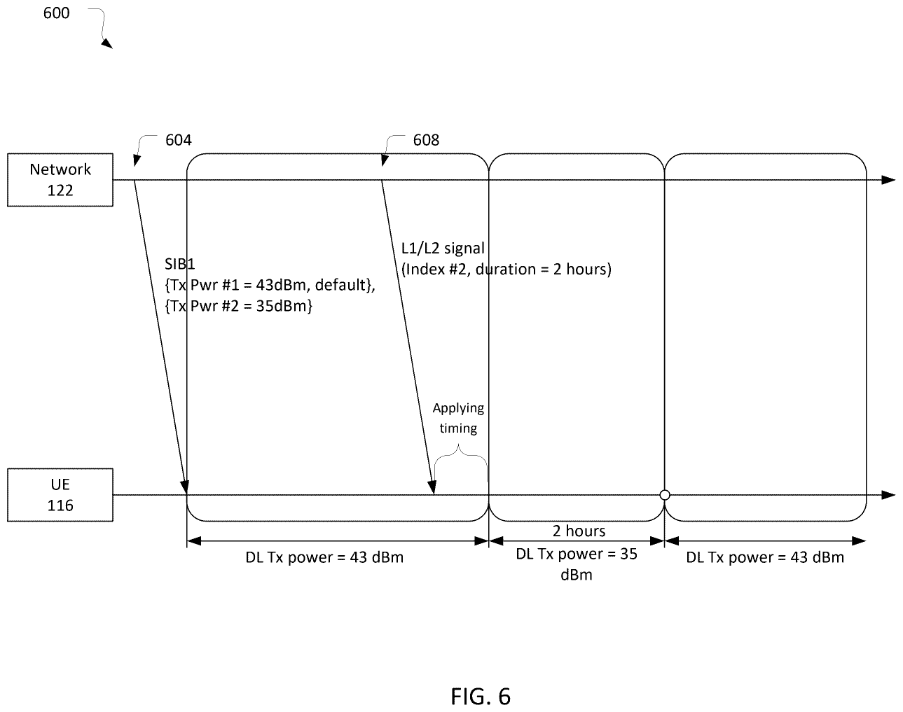

FIG. 6 illustrates an adjustment operation 600 in accordance with some embodiments. The adjustment operation 600 may provide different DL Tx power configurations and an applied value indication using a combination of RRC signaling and L1/L2 signaling.

At 604, the network 122 may configure a plurality of DL Tx power configurations using RRC signaling. For example, the network 122 may transmit SIB1 at 504 with a first DL Tx power configuration and a second DL Tx power configuration. The first configuration may provide a transmit power of 43 dBm. The network 122 may also provide an indication that the first configuration is the default or initial configuration to be applied. This indication may be explicit or implied by, for example, order of presentation. The second configuration may provide a transmit power of 35 dBm.

The UE 116 may, upon receiving the SIB1, apply the first configuration without delay as it is the designated default configuration. At 608, the network 122 may send an L1/L2 signal with an indication that the second configuration is to be used. The L1/L2 signal may also include an indication of the duration for which the second configuration is to be used (two hours, as shown). The UE 116 may then apply the second configuration, after an applying timing, and use a DL Tx power of 35 dBm, for the indicated duration (e.g., two hours). After the duration expires, and assuming the UE 116 has not received any additional L1/L2 signaling indicating a new applied value, the UE 116 may revert to applying the first configuration as the default configuration.

The applying timing may provide the UE 116 with sufficient time to transition from applying the first configuration to applying the second configuration. The applying timing may be predefined in a TS or configured by the network 122. The applying timing may also be applicable to other embodiments.

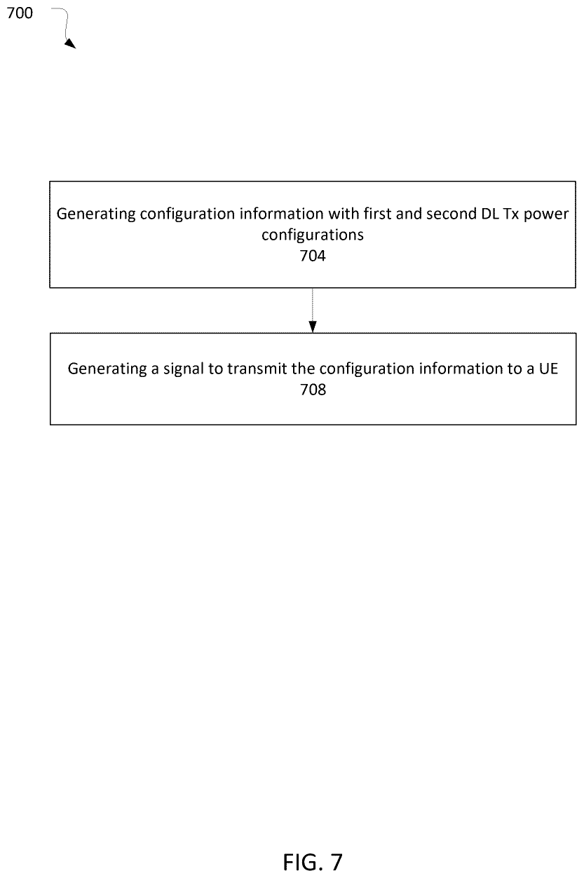

FIG. 7 illustrates an operational flow/algorithmic structure 700 in accordance with some embodiments. The operation flow/algorithmic structure 700 may be performed or implemented by a network device such as, for example, a node of network 122, network device 1100; or components thereof, for example, baseband processor circuitry 1104A.

The operation flow/algorithmic structure 700 may include, at 704, generating configuration information with a first DL Tx power configuration and a second DL Tx power configuration. The DL Tx power configurations may be candidate configurations that provide different DL Tx power values to be used by a UE when predefined conditions are met. While some embodiments describe the configuration information including two DL Tx power configurations, other embodiments may include more than two DL Tx power configurations.

In some embodiments, the configuration information may also indicate which configuration of the candidate configurations is to be considered the default or initial configuration.

In some embodiments, the candidate configurations may be per SSB-configurations.

The operation flow/algorithmic structure 700 may further include, at 708, generating a signal (e.g., a configuration signal) to include the configuration information. In some embodiments, the configuration signal may be generated by baseband circuitry and output to other components of a network device for transmission to a UE. The configuration signal may be an RRC signal, e.g., a SIB1, that is to be transmitted by PDSCH.

In some embodiments, the network device may transmit another signal (e.g., an indicator signal) that is used to indicate that the UE is to use a configuration from the candidates configurations provided in the configuration information. The indicator signal may be an L1/L2 signal that includes an identifier or index associated with the indicated configuration.

In some embodiments, the indicator signal may comprise a setting indication that is associated with the indicated configuration. For example the setting indication may indicate a NES state, cell DRX/DTX state, a number of SSBs, or an SSB periodicity. In this embodiment, the indicator signal may be an RRC signal or an L1/L2 signal.

In some embodiments, the configuration signal may include one or more conditions associated with each configuration. If the one or more conditions are met, the associated configuration is to be used by the UE. In some embodiments, these conditions are initially in active when provided by the configuration signal. While the conditions are active, the UE may use a default configuration. An indicator signal may thereafter activate these conditions for a period of time. When the conditions are active, the UE may determine which conditions are met and use the associated configuration.

In some embodiments, timing information may be provided in the configuration signal or the indicator signal. The timing information may provide information on the time in which the UE is to utilize one or more configurations. The timing information may indicate a starting point, an ending point, or a duration. In some embodiments, the timing information may include an offset to define the starting point relative to receipt of the indication signal.

In some embodiments, timing information may be provided for a subset of the candidate configurations. For example, the timing information may just be provided for an indicated configuration. In other embodiments, the timing information may be provided for all of the candidate configurations. For example, each candidate configuration may be associated with the time period in which the configuration is to be used.

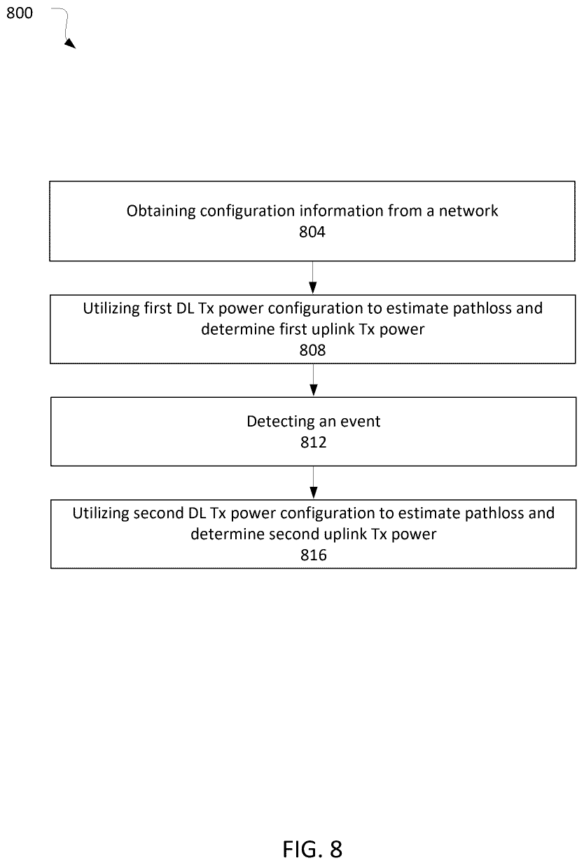

FIG. 8 illustrates an operational flow/algorithmic structure 800 in accordance with some embodiments. The operation flow/algorithmic structure 800 may be performed or implemented by a UE such as, for example, UE 116 or 1000; or components thereof, for example, baseband processor 1004A.

The operation flow/algorithmic structure 800 may include, at 804, obtaining configuration information from a network. The configuration information may configure a plurality of candidate DL Tx power configurations. The configuration information may be similar to that described with respect to operation 704 or elsewhere herein.

The operation flow/algorithmic structure 800 may further include, at 808, utilizing a first DL Tx power configuration to estimate a pathloss and determine a first uplink transmit power. In some embodiments, the first DL Tx power configuration may be used because it is indicated as a default or initial configuration in the configuration information. In other embodiments, the first DL Tx power configuration may be used because its associated conditions are met.

The operation flow/algorithmic structure 800 may further include, at 812, detecting an event. In some embodiments, the event may be determining one or conditions associated with a second DL Tx power configuration are met. The conditions may relate to timing information (for example, a starting point, an ending point, a duration, an offset, etc.) associated with one or more of the configurations. In general, the conditions may be similar to that described elsewhere herein.

The event may be detected based on: a time period associated with the second DL Tx power configuration; a location of a UE (where the location is associated with the second downlink transmit power configuration); receipt of an indicator signal that includes an identifier or index associated with the second DL Tx power configuration; or detecting a signal that includes a setting indication associated with the second DL Tx power configuration (where the setting indication indicates an NES state, cell DRX/DTX state, a number of SSBs, or an SSB periodicity).

In some embodiments, the event may be detected based on a need to perform an initial access outside of a SIB modification procedure. For example, the UE may receive a first DL Tx power configuration in a first SIB1. The first SIB1 may also indicate that the UE is to reacquire a SIB upon performing an initial access. If the UE determines that it needs to perform an initial access (and it determines this without a network indication that a SIB modification has taken place), the UE will receive a second SIB1 that includes a second DL Tx power configuration.

The operation flow/algorithmic structure 800 may further include, at 816, utilizing the second DL Tx power configuration to estimate pathloss and determine second uplink Tx power.

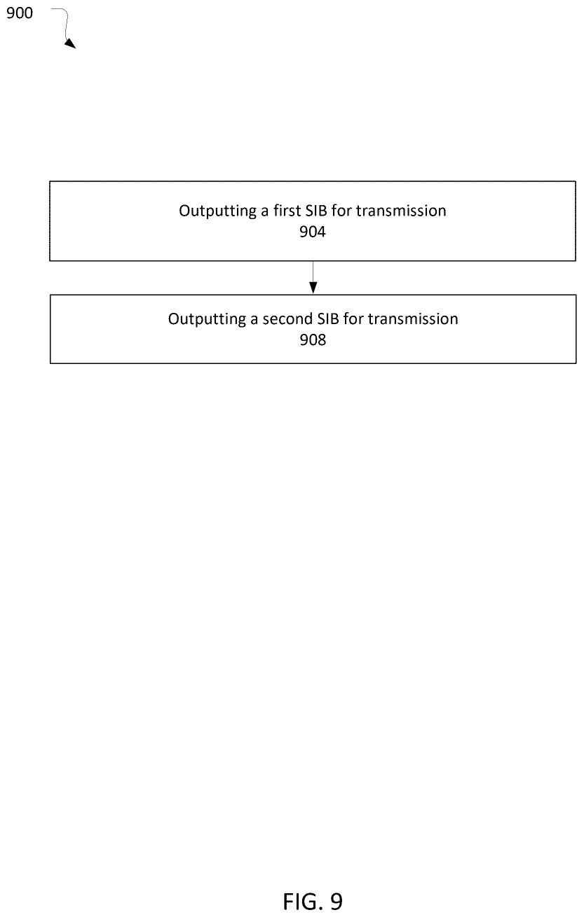

FIG. 9 illustrates an operational flow/algorithmic structure 900 in accordance with some embodiments. The operation flow/algorithmic structure 900 may be performed or implemented by a network device such as, for example, a node of network 122, network device 1100; or components thereof, for example, baseband processor circuitry 1104A

The operation flow/algorithmic structure 900 may include, at 904, outputting a first SIB for transmission. The first SIB may be a SIB1 that includes a first downlink transmit power configuration. In some embodiments, the first SIB may also include an indicator that a UE needs to reacquire system information from a SIB1 when performing an initial access. Thus, the UE will reacquire SIB1 even without a SIB modification procedure taking place.

The operation flow/algorithmic structure 900 may further include, at 908, outputting a second SIB before transmission. The second SIB may be a SIB1 that includes a second downlink transmit power configuration. The second SIB may be output for transmission without performing an associated SIB modification procedure.

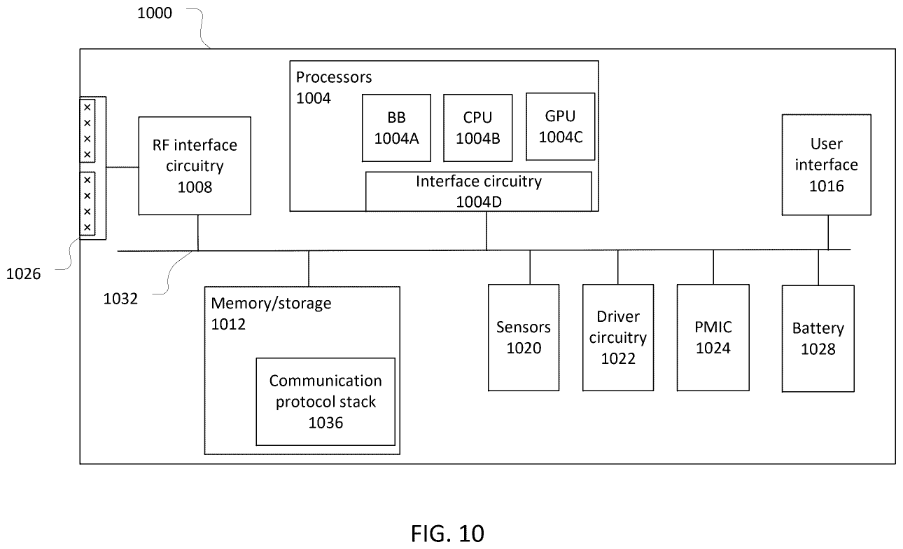

FIG. 10 illustrates a UE 1000 in accordance with some embodiments. The UE 1000 may be similar to and substantially interchangeable with UE 116.

The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1000 may include processors 1004, RF interface circuitry 1008, memory/storage 1012, user interface 1016, sensors 1020, driver circuitry 1022, power management integrated circuit (PMIC) 1024, antenna 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1032, which may represent any type of interface, input/output, bus (local, system, or expansion), transmission line, trace, or optical connection that allows various circuit components (on common or different chips or chipsets) to interact with one another.

The processors 1004 may include processor circuitry such as, for example, baseband processor (BB) 1004A, central processor unit (CPU) 1004B, and graphics processor unit (GPU) 1004C. The processors 1004 may include any type of circuitry or processor circuitry that executes or otherwise operates computer-executable instructions, such as program code, software modules, or functional processes from memory/storage 1012 to cause the UE 1000 to perform DL cell-specific transmit power adjustment as described herein. The processors 1004 may also include interface circuitry 1004D to communicatively couple the processor circuitry with one or more other components of the UE 1000.

In some embodiments, the baseband processor 1004A may access a communication protocol stack 1036 in the memory/storage 1012 to communicate over a 3GPP compatible network. In general, the baseband processor 1004A may access the communication protocol stack 1036 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1008.

The baseband processor 1004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform various operations described herein. The memory/storage 1012 may store NP information upon which the NP switching procedures described herein are based.

The memory/storage 1012 includes any type of volatile or non-volatile memory that may be distributed throughout the UE 1000. In some embodiments, some of the memory/storage 1012 may be located on the processors 1004 themselves (for example, memory/storage 1012 may be part of a chipset that corresponds to the baseband processor 1004A), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, or phased array antennas. The antenna 1026 may have one or more panels designed for specific frequency bands including bands in FR1 or FR2.

The user interface 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensors 1020 and control and allow access to sensors 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power-saving mechanisms of the UE 1000 including DRX as discussed herein.

A battery 1028 may power the UE 1000, although in some examples the UE 1000 may be mounted deployed in a fixed location and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

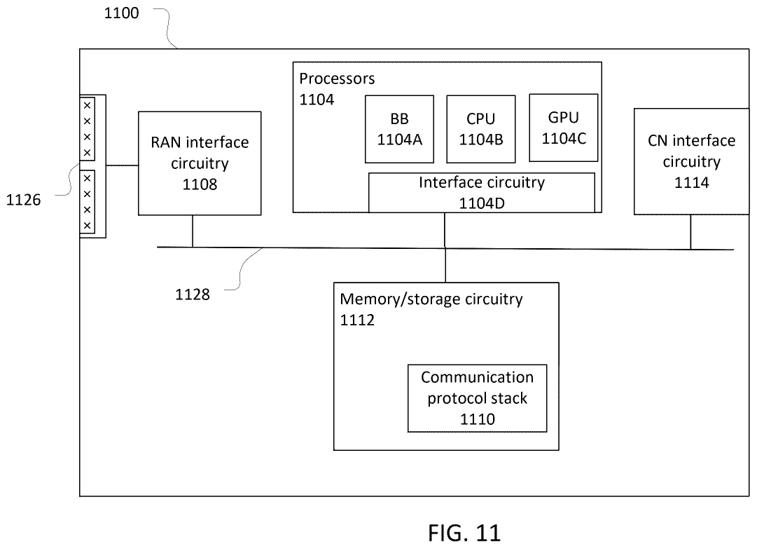

FIG. 11 illustrates a network device 1100 in accordance with some embodiments. The network device 1100 may be similar to and substantially interchangeable with a node of the network 122 (or a node of a terrestrial network).

The network device 1100 may include processors 1104, RF interface circuitry 1108 (if implemented as a base station), core network (CN) interface circuitry 1114, memory/storage circuitry 1112, and antenna structure 1126.

The components of the network device 1100 may be coupled with various other components over one or more interconnects 1128.

The processors 1104, RF interface circuitry 1108, memory/storage circuitry 1112 (including communication protocol stack 1110), antenna structure 1126, and interconnects 1128 may be similar to like-named elements shown and described with respect to FIG. 10.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage circuitry 1112 to cause the network device 1100 to perform DL cell-specific transmit power adjustment as described herein. The processors 1104 may also include interface circuitry 1104D to communicatively couple the processor circuitry with one or more other components of the network device 1100.

The CN interface circuitry 1114 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1100 via a fiber optic or wireless backhaul. The CN interface circuitry 1114 may include one or more dedicated processors or FPGAs to communicate using one or more of the aforementioned protocols. In some implementations, the CN interface circuitry 1114 may include multiple controllers to provide connectivity to other networks using the same or different protocols.

In some embodiments, the network device 1100 may be a base station and may be coupled with satellites using the antenna structure 1126. In other embodiments, the network device 1100 may be a satellite and may be coupled with the base station using the antenna structure 1126.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

In the following sections, further exemplary embodiments are provided.

Example 1 includes a method comprising: generating configuration information that includes a first downlink transmit power configuration and a second downlink transmit power configuration; and generating a signal to include the configuration information, the signal to be transmitted to a user equipment (UE).

Example 2 includes a method of example 1 or some other example herein, wherein the signal is a first signal and the method further comprises: generating a second signal to be transmitted to the UE after transmission of the first signal, the second signal to indicate that the UE is to use the second downlink transmit power configuration.

Example 3 includes the method of example 2 or some other example herein, wherein the second signal comprises a layer 1 or layer 2 signal and includes an identifier or index associated with the second downlink transmit power configuration.

Example 4 includes a method of example 2 or some other example herein, wherein the second signal comprises a setting indication associated with the second downlink transmit power configuration, wherein the setting indication is to indicate a network energy saving (NES) state, a cell discontinuous reception (DRX)/discontinuous transmission (DTX) state, a number of synchronization signal blocks (SSBs), or an SSB periodicity.

Example 5 includes the method of example 1 or 2 or some other example herein, wherein the first or second signal includes timing information associated with the first downlink transmit power configuration or the second downlink transmit power configuration.

Example 6 includes a method of example 1 or some other example herein, wherein the configuration information includes timing information to indicate a starting point or duration in which the UE is to use the second downlink transmit power configuration.

Example 7 includes a method of example 6 or some other example herein, wherein the timing information comprises an offset value to define a starting point for use of the second downlink transmit power configuration relative to receipt of an indication that the UE is to use the second downlink transmit power configuration.

Example 8 includes a method of example 6 or some other example herein, wherein the timing information is to further indicate a starting point or duration in which the UE is to use the first downlink transmit power configuration.

Example 9 includes the method of example 1 or some other example herein, wherein the configuration information is to indicate the first downlink transmit power configuration is a default configuration.

Example 10 includes the method of example 1 or some other example herein, wherein the first downlink transmit power configuration and the second downlink transmit power configuration are per-synchronization signal block (SSB) configurations.

Example 11 includes a method of example 1 or some other example herein, wherein the signal is a first signal, the configuration information further includes a condition associated with the second downlink transmit power configuration and the method further comprises: generating a second signal to be transmitted to the UE after transmission of the first signal, the second signal to activate the condition associated with the second downlink transmit power configuration.

Example 12 includes a method comprising: obtaining configuration information from a network, the configuration information to includes a first downlink transmit power configuration and a second downlink transmit power configuration; utilizing the first downlink transmit power configuration to estimate a first pathloss and determine a first uplink transmit power; detecting an event; utilizing, based on detecting the event, the second downlink transmit power configuration to estimate a second pathloss and determine a second uplink transmit power.

Example 13 includes a method of example 12 or some other example herein, wherein detecting the event comprises: detecting a time period associated with the second downlink transmit power configuration.

Example 14 includes a method of example 12 or some other example herein, wherein detecting the event comprises: detecting a location of a user equipment, wherein the location is associated with the second downlink transmit power configuration.

Example 15 includes a method of example 12 or some other example herein, wherein detecting the event comprises: detecting a signal from the network, wherein signal is a layer 1 (L1) or layer 2 (L2) signal that includes an identifier or index associated with the second downlink transmit power configuration.

Example 16 includes a method of example 12 or some other example herein, wherein detecting the event comprises: detecting a signal from the network, wherein the signal includes a setting indication associated with the second downlink transmit power configuration, wherein the setting indication is to indicate a network energy saving (NES) state, a cell discontinuous reception (DRX)/discontinuous transmission (DTX) state, a number of synchronization signal blocks (SSBs), or an SSB periodicity.

Example 17 includes the method of example 15 or 16 or some other example herein, further comprising: switching to the second downlink transmit power configuration immediately upon detecting the signal from the network.

Example 18 includes the method of any one of examples 12-16 or some other example herein, further comprising: receiving timing information associated with the first downlink transmit power configuration or the second downlink transmit power configuration; and detecting the event based on the timing information.

Example 19 includes the method of example 18 or some other example herein, wherein the timing information is to indicate a starting point or duration in which the second downlink transmit power configuration is to be used.

Example 20 includes a method of example 19 or some other example herein, wherein the timing information comprises an offset value to define a starting point for use of the second downlink transmit power configuration relative to receipt of an indication that the second downlink transmit power configuration is to be used.

Example 21 includes a method of example 18 or some other example herein, wherein the timing information is to further indicate a starting point or duration in which the first downlink transmit power configuration is to be used.

Example 22 includes a method of example 12 or some other example herein, wherein the configuration information is to indicate the first downlink transmit power configuration is a default configuration.

Example 23 includes a method of example 12 or some other example herein, wherein the first downlink transmit power configuration and the second downlink transmit power configuration are per-synchronization signal block (SSB) configurations.

Example 24 includes a method of example 12 or some other example herein, wherein obtaining the configuration information includes: obtaining the first downlink transmit power configuration from a first system information block (SIB); and obtaining the second downlink transmit power configuration from a second SIB.

Example 25 includes a method of example 24 some other example herein, wherein detecting the event comprises: determining a need to perform an initial access outside of a SIB modification procedure.

Example 26 includes a method comprising: outputting a first system information block (SIB), the first SIB to include a first downlink transmit power configuration; outputting a second SIB, the second SIB to include a second downlink transmit power configuration, wherein the second SIB is output for transmission without performing an associated SIB modification procedure.

Example 27 includes a method of example 26 or some other example herein, wherein the first SIB includes an indicator that a UE is to reacquire SIB1 information before performing an initial access.

Another example may include an apparatus comprising means to perform one or more elements of a method described in or related to any of examples 1-27, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-27, or any other method or process described herein.

Another example may include an apparatus comprising logic, modules, or circuitry to perform one or more elements of a method described in or related to any of examples 1-27, or any other method or process described herein.

Another example may include a method, technique, or process as described in or related to any of examples 1-27, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-27, or portions thereof.

Another example may include a signal as described in or related to any of examples 1-27, or portions or parts thereof.

Another example may include a datagram, information element, packet, frame, segment, PDU, or message as described in or related to any of examples 1-27, or portions or parts thereof, or otherwise described in the present disclosure.

Another example may include a signal encoded with data as described in or related to any of examples 1-27, or portions or parts thereof, or otherwise described in the present disclosure.

Another example may include a signal encoded with a datagram, IE, packet, frame, segment, PDU, or message as described in or related to any of examples 1-27, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-27, or portions thereof.

Another example may include a computer program comprising instructions, wherein execution of the program by a processing element is to cause the processing element to carry out the method, techniques, or process as described in or related to any of examples 1-27, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising
generating configuration information that includes a first downlink transmit power configuration and a second downlink transmit power configuration; and
generating a signal to include the configuration information, the signal to be transmitted to a user equipment (UE).

2. The method of claim 1, wherein the signal is a first signal and the method further comprises:
generating a second signal to be transmitted to the UE after transmission of the first signal, the second signal to indicate that the UE is to use the second downlink transmit power configuration.

3. The method of claim 2, wherein the second signal comprises a layer 1 or layer 2 signal and includes an identifier or index associated with the second downlink transmit power configuration.

4. The method of claim 2, wherein the second signal comprises a setting indication associated with the second downlink transmit power configuration, wherein the setting indication is to indicate a network energy saving (NES) state, a cell discontinuous reception (DRX)/discontinuous transmission (DTX) state, a number of synchronization signal blocks (SSBs), or an SSB periodicity.

5. The method of claim 1, wherein the first signal or the second signal includes timing information associated with the first downlink transmit power configuration or the second downlink transmit power configuration.

6. The method of claim 1, wherein the configuration information includes timing information to indicate a starting point or duration in which the UE is to use the second downlink transmit power configuration.

7. The method of claim 6, wherein the timing information comprises an offset value to define a starting point for use of the second downlink transmit power configuration relative to receipt of an indication that the UE is to use the second downlink transmit power configuration.

8. The method of claim 6, wherein the timing information is to further indicate a starting point or duration in which the UE is to use the first downlink transmit power configuration.

9. The method of claim 1, wherein the configuration information is to indicate the first downlink transmit power configuration is a default configuration.

10. The method of claim 1, wherein the first downlink transmit power configuration and the second downlink transmit power configuration are per-synchronization signal block (SSB) configurations.

11. The method of claim 1, wherein the signal is a first signal, the configuration information further includes a condition associated with the second downlink transmit power configuration and the method further comprises:
generating a second signal to be transmitted to the UE after transmission of the first signal, the second signal to activate the condition associated with the second downlink transmit power configuration.

12. One or more non-transitory, computer-readable media having instructions that, when executed, cause processing circuitry to:
obtain configuration information from a network, the configuration information to includes a first downlink transmit power configuration and a second downlink transmit power configuration;
utilize the first downlink transmit power configuration to estimate a first pathloss and determine a first uplink transmit power;
detect an event; and
utilize, based on detection of the event, the second downlink transmit power configuration to estimate a second pathloss and determine a second uplink transmit power.

13. The one or more non-transitory, computer-readable media of claim 12, wherein to detect the event the processing circuitry is to:
detect a time period associated with the second downlink transmit power configuration.

14. The one or more non-transitory, computer-readable media of claim 12, wherein to detect the event the processing circuitry is to:
detect a location of a user equipment, wherein the location is associated with the second downlink transmit power configuration.

15. The one or more non-transitory, computer-readable media of claim 12, wherein to detect the event the processing circuitry is to:
detect a signal from the network, wherein signal is a layer 1 (L1) or layer 2 (L2) signal that includes an identifier or index associated with the second downlink transmit power configuration.

16. The one or more non-transitory, computer-readable media of claim 15, wherein the instructions, when executed, further cause the processing circuitry to:
switch to the second downlink transmit power configuration immediately upon detection of the signal from the network.

17. The one or more non-transitory, computer-readable media of claim 12, wherein to detect the event the processing circuitry is to:
detect a signal from the network, wherein the signal includes a setting indication associated with the second downlink transmit power configuration, wherein the setting indication is to indicate a network energy saving (NES) state, a cell discontinuous reception (DRX)/discontinuous transmission (DTX) state, a number of synchronization signal blocks (SSBs), or an SSB periodicity.

18. The one or more non-transitory, computer-readable media of claim 12, wherein the instructions, when executed, further cause the processing circuitry to:
receive timing information associated with the first downlink transmit power configuration or the second downlink transmit power configuration; and
detect the event based on the timing information.

19. An apparatus comprising:
processing circuitry to
output a first system information block (SIB), the first SIB to include a first downlink transmit power configuration;
output a second SIB, the second SIB to include a second downlink transmit power configuration, wherein the second SIB is output for transmission without performing an associated SIB modification procedure; and
interface circuitry coupled with the processing circuitry to enable communication.

20. The apparatus of claim 19, wherein the first SIB includes an indicator that a user equipment (UE) is to reacquire SIB1 information before performing an initial access.
